(19) United States
(12) Patent Application Publication
(10) Pub. No.: US 2026/0080342 A1
(43) Pub. Date: Mar. 19, 2026

(54) Machine Learning Techniques for Improving Creative Impact

(71) Applicant: NBCUniversal Media, LLC, New York, NY (US)

(72) Inventors: Ankush Kamlakar Morey, Cincinatti, OH (US); Zeidee Sorbera, Weehawken, NJ (US)

(21) Appl. No.: 18/887,669

(22) Filed: Sep. 17, 2024

(51) Int. Cl. G06Q 10/0639; G06N 20/00

(52) U.S. Cl. CPC G06Q 10/06393; G06N 20/00

(57) ABSTRACT

Systems and methods for creative analysis using a two-stage machine learning creative analysis engine are provided. The two-stage machine learning creative analysis engine includes a first stage machine learning model that predicts a KPI value for a creative based upon the operational features of the creative. Residuals of the first stage machine learning model are provided as target variables to a second stage machine learning model that predicts the residuals using creative features of the creative.

### BACKGROUND

The present disclosure relates generally to improved systems and techniques for identifying an impact of creative factors using machine learning models. Specifically, a two-stage machine learning may be used to identify operational and creative aspect impacts with respect to creatives, enabling improved and efficient machine-based forecasting and suggestions for operational and/or creative aspect modifications for more effective creatives.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Traditionally, content effectiveness has been inefficient with limited ability to test the effectiveness on a large scale. For example, in advertising content, advertisers have typically vetted or tested a draft advertisement (e.g., draft commercial) with, for example, a limited-size control group to determine various aspects of the draft advertisement that play well and/or do not play well to the control group. Based on an outcome of the vetting and testing techniques, the final advertisement employed in an ad campaign may be altered from the draft advertisement. In some cases, iterations of vetting occur before finalized content is created.

As may be appreciated, the nature of the type of manual, limited-size control group testing may be quite costly, both monetarily and in time. Further, because of the limited-size of the control group, the vetting may lack input for a wider audience of the vast content provision platforms that are available today.

In recent years, the world has evolved to capture data regarding many aspects of content provision platforms, creative provisioning, etc. Despite the vast amount of data available, machine learning models have not efficiently and effectively harnessed this information to derive KPI predictions and/or operational and/or creative aspect modification recommendations to increase creative effectiveness.

Indeed, advertisers may not have complete access to stored data that may create more accurate KPI scoring predictions, such as platform-specific data, which could otherwise inform of key aspects that may drive content effectiveness. As an example, an advertiser may not have access to certain historical Key Performance Indicators (KPIs) associated with previous advertisements and with specific aspects (e.g., creative aspects) of such previous advertisements displayed on a specific platform. As another example, the control group employed by the advertiser may not be representative of platform-specific groups that will ultimately view the final advertisement, while real-world data of the platform-specific groups (or a larger user pool) may be available.

To the extent the advertiser does have complete access to the above-described data, the advertiser may not adequately leverage such data to inform the above-described alterations. As an example, the advertiser may not adequately isolate an impact of various creative aspects (e.g., visual aspects, auditory aspects, thematic aspects, etc.) on KPIs. This lack of access to data and/or the inability to adequately leverage large data sets may negatively impact the quality of a final advertisement and/or the performance of an ad campaign employing the final advertisement. Further, the vast amount of data may not be feasibly analyzed by manual human intervention. Thus, new and improved techniques that enable machine-learning based analysis of this data, without relying on human subjectivity is desirable.

### BRIEF DESCRIPTION

Certain aspects commensurate in scope with the originally claimed subject matter are summarized below. These aspects are not intended to limit the scope of the claimed subject matter, but rather these aspects are intended only to provide a brief summary of possible forms of the subject matter. Indeed, the subject matter may encompass a variety of forms that may be similar to or different from the aspects set forth below.

In one aspect. a system includes a two-stage creative analysis machine learning engine that includes a first stage machine learning model, configured to predict a key performance indicator (KPI) value for a creative based upon operational features of the creative and a second stage machine learning model, configured to predict residuals of the first stage machine learning model based upon creative features of the creative.

In one aspect, a computer-implemented method includes: predicting, via a first stage machine learning model, a key performance indicator (KPI) value for a creative based upon operational features of the creative; and predicting, via a second stage machine learning model, residuals of the first stage machine learning model based upon creative features of the creative.

In one aspect, a tangible, non-transitory, computer-readable medium, includes computer-readable instructions that, when executed by one or more processors of one or more computers, cause the one or more computers to: predict, via a first stage machine learning model, a key performance indicator (KPI) value for a creative based upon operational features of the creative; predict, via a second stage machine learning model, residuals of the first stage machine learning model based upon creative features of the creative; and present, via a creative dashboard, the predicted KPI value and the predicted residuals.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram, illustrating a system having a set of two-stage creative analysis engines that use machine learning to provide predictions and/or modification suggestions for input creatives, in accordance with certain aspects of the current application;

FIG. 2 is a flowchart, illustrating a process for training the two-stage creative analysis engine, in accordance with certain aspects of the current application;

FIG. 3 is a flowchart, illustrating a process for implementing creative analysis using the two-stage creative analysis engine, in accordance with certain aspects of the current application;

FIG. 4 is a data flow diagram, illustrating how recommendations are generated using the two-stage creative analysis engine, in accordance with certain aspects of the current application;

FIG. 5 is a schematic diagram, illustrating a data structure storing a resultant recommendation, in accordance with certain aspects of the current application;

FIG. 6A is a schematic diagram of a graphical user interface (GUI) of creative dashboard that provides key performance indicator (KPI) scorings and particular information about a particular selected KPI (e.g., here Attention Score), in accordance with aspects of the present techniques; and

FIG. 6B is a schematic diagram of the GUI of FIG. 6A, with a modified KPI selection (e.g., Search), in accordance with aspects of the present techniques.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As discussed in greater detail below, the present aspects described herein facilitate and improve key performance indicator predictions and operational and/or creative aspect modification recommendations to improve creative effectiveness. Specifically, a two-stage creative analysis machine learning engine may be used to facilitate efficient and effective KPI scoring predictions and/or operational and/or creative feature modification recommendations, based upon a vast amount of training data that is infeasible for human analysis.

As used herein, KPIs refer to effectiveness indicators with respect to a creative. For example, a non-exhaustive list of KPIs might include: an attention index that provides a measure of how well a creative keeps the attention of a viewing audience, a search measurement, indicative of a level of searching (e.g., Internet searching) that is performed in response to viewing the creative, a memorability score that provides a measure of how memorable the creative is to the viewing audience, a brand memorability measurement that indicates how well the audience remembers the brand as a function of viewing the creative, a likability measurement indicative of how well the audience liked the creative, a message memorability measurement indicative of how well the audience remembered the message of the creative after viewing the creative, etc.

Further, as used herein, creative features refer to the subject matter features of the creative. For example, creative features might include particular themes of the creative, particular sentiments conveyed by (or not conveyed by) the creative, particular genre classifications of the creative, particular objects present (or not present) in the creative, etc.

Operational features and/or variables may refer to variables regarding operation of the creatives, such as how the creatives are delivered. For example, operational features and/or variables may include a number of airings across different networks, the platforms where the creative were delivered, particular airing schedules, etc.

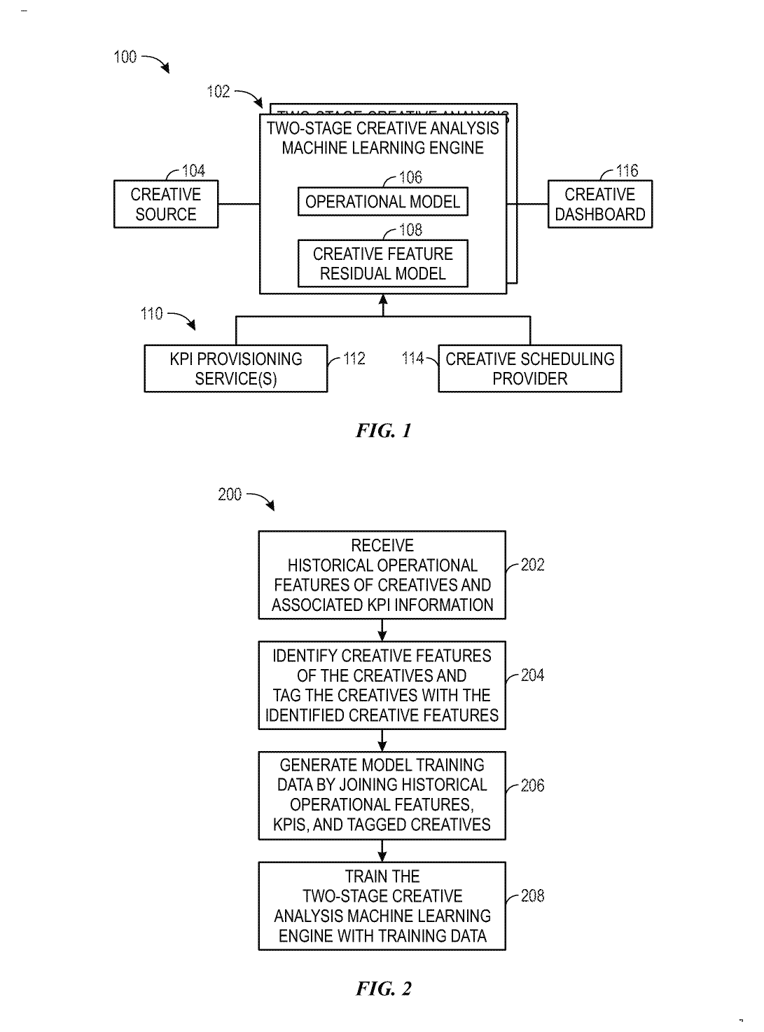

With the preceding in mind, the following figures relate to systems and processes for training and using a two-stage machine learning engine to provide such creative KPI predictions and/or to provide recommendations of operational and/or creative aspect modifications that may improve a creative’s effectiveness (e.g., increase the creative’s KPI scores). Turning now to the figures, FIG. 1 is a schematic diagram, illustrating a system 100 having a set of two-stage creative analysis engines 102 that use machine learning to provide predictions and/or modification suggestions for creatives from a creative source104, in accordance with certain aspects of the current application.

As used herein, the machine learning may refer to algorithms and statistical models that the set of two-stage creative analysis engines 102 use to perform a specific task with or without explicit instructions. For example, a machine learning process may generate a mathematical model based on a sample of the clean data, known as “training data,” in order to make predictions or decisions without being explicitly programmed to perform the specific task. Depending on the inferences to be made, different machine learning algorithms may be used to analyze the data.

In some scenarios, a supervised machine learning algorithm may be implemented using a mathematical model of a set of data samples referred to as the “training data” and containing both inputs and desired outputs. Each data sample may include one or more inputs and corresponding desired one or more outputs, also known as supervisory signals. In the mathematical model, each data sample may be represented by an array or vector, sometimes called a feature vector, and the training data may be represented by a matrix. Through iterative optimization of an objective function, the supervised machine learning algorithm may learn a function (e.g., optimal function) that can be used to predict outputs associated with new inputs. That is, the optimal function may allow the supervised machine learning algorithm to correctly predict corresponding outputs for certain inputs that are not presented in the training data. Such algorithm that improves the accuracy of its outputs or predictions over time is said to have learned to perform the specific task.

Supervised learning algorithms may include classification and regression. Classification algorithms are used when the outputs are restricted to a limited set of values, and regression algorithms are used when the outputs may have any numerical value within a range. Similarity learning is an area of supervised machine learning closely related to regression and classification, but the goal is to learn from examples using a similarity function that measures how two objects (e.g. two sets of measured performance data from two different systems) are similar or related.

Additionally and/or alternatively, in some scenarios, an unsupervised machine learning algorithm may be implemented (e.g., when particular output types are not known). The unsupervised learning algorithm may take a set of data samples that contains only inputs, and find structure in the driving data samples, such as grouping or clustering of the data samples. The unsupervised learning algorithm, therefore, learn from the data samples that have not been labeled, classified, or categorized. Instead of responding to feedback, unsupervised learning algorithms identify commonalities in the data and react (e.g., predict outputs) based on the presence or absence of such commonalities in each new piece of data.

Cluster analysis is the assignment of a set of observations (e.g., on data samples) into subsets (called clusters) so that observations within the same cluster are similar according to one or more predesignated criteria (e.g., conditions), while observations drawn from different clusters are dissimilar. Different clustering techniques make different assumptions on the structure of the data, often defined by some similarity metric and evaluated, for example, by internal compactness, or the similarity between objects of the same cluster.

The set of two-stage creative analysis engines 102 may include one or more two-stage creative analysis engines, depending on how particular operational segments are divided and/or how many KPIs are to be predicted. For example, individual two-stage creative analysis engines may be generated for different genres, time periods, etc., where more granular divisions may provide more efficient and/or effective predictions, but may require more historical data. For example, when making predictions, subject matter coverage areas may be one division where individual two-stage creative analysis engines may be used. For example, creative effectiveness may diverge between Olympics Coverage, when compared with Superbowl Coverage, and/or Golf Coverage. Accordingly, each of these coverage areas/times may use their own associated two-stage creative analysis engine for predictions. Further, divisions based upon platforms may also warrant different two-stage creative analysis engines. For example, creative effectiveness on a network television platform may diverge from effectiveness on an online streaming platform. Further, in some scenarios, individual two-stage creative analysis engines 102 may be generated for each different KPI to be predicted.

As illustrated, each of the set of two-stage creative analysis engines 102 may include two stages of applied machine learning models that are used to identify KPI predictions and/or operational and/or creative aspect modification recommendations for creatives from the creative source 104. Specifically, in a first stage, the creatives from the creative source 104 are applied first to an operational model 106. Then, in the second stage, a creative feature residuals model 108 is used to predict residuals of the first stage using creative features associated with the creatives from the creative source. In this manner, the results of the set of two-stage creative analysis machine learning engine 102 may be primarily predicted based upon operational variables. The predictions may then be fine-tuned using creative aspects of the creatives.

As will be discussed in more detail below, the set of two-stage creative analysis machine learning engine 102 may generate effectiveness predictions (e.g., KPI score predictions). Further, the set of two-stage creative analysis machine learning engine 102 creative aspects that may improve these predictions.

To generate the predictions, the operational model(s) 106 and the creative feature residual model(s) 108 may be trained using historical data sources 110. The historical data sources 110 may provide historical operational data of historical creatives, historical creative aspects (e.g., metadata) of the historical creatives, and historical KPIs associated with the historical creatives. The historical data sources 110 may include, for example, KPI provisioning service(s) 112 that provide historical KPI scores for the historical creatives. Further, the historical data sources 110 may include creative scheduling provider(s) 114 that provides historical scheduling of the historical creatives, which may include a time, date, platform, or other variables relating to historical creatives’ scheduling/placement. The historical data sources 110 are not limited to the displayed data source types. Indeed, many other historical data sources may be useful in the creative analysis. For example, a historical data source 110 may include a content management system that maintains metadata indicative of the creative aspects of the historical creatives.

Using the trained operational model 106 and trained creative feature residual model 108, the set of two-stage creative analysis engines 102 may generate and provide, to a creative dashboard 116 for display, predicted effectiveness scores and/or suggested modifications for creatives provided by the creative source 104. The creative dashboard 116 may present the predictions and/or suggested modifications, as will be discussed in more detail below.

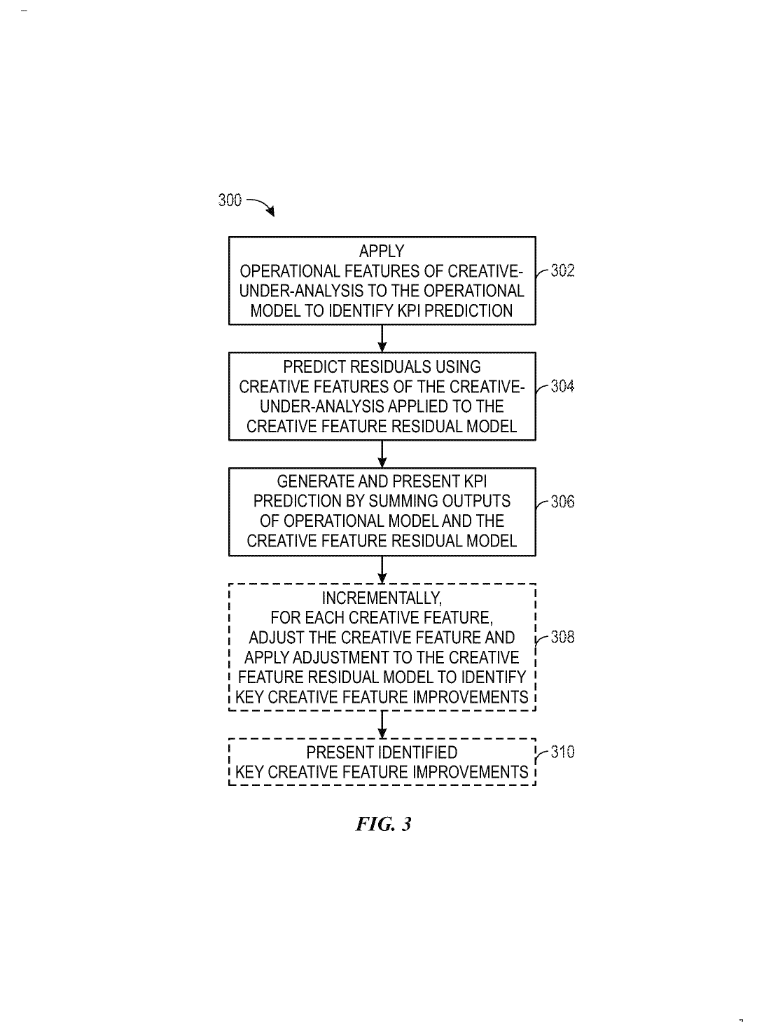

Having provided an overview of the system 100, the discussion continues with a more detailed discussion of training of the models discussed in FIG. 1. With this in mind, FIG. 2 is a flowchart, illustrating a process 200 for training the two-stage creative analysis engine, in accordance with certain aspects of the current application.

The process 200 begins with receiving historical operational features of creatives and associated KPI information from historical data sources (block 202). For example, one or more KPI vendors (e.g., KPI Provisioning Service(s) 112) may provide historical KPIs for creatives. Further, historical data sources (e.g., Creative Scheduling Provider(s) 114) may provide historical operational features/variables of the creatives.

Creative features of the creatives are identified and tagged with the identified creative features (block 204). For example, the creatives may be passed through a computer vision service and/or a generative artificial intelligence service that may identify the creative features within the creative, such as a comedic theme based upon script or language used in the creative, objects presented in the creative (e.g., a cat, a dog, a celebrity, a bicycle) based upon computer vision or other image recognition techniques, etc.

In some situations, not all operational and creative features and historical KPIs may be available from a single source. In such situations, model training data is generated by joining the historical operational features, KPIs, and tagged creatives (block 206). The joining may be performed based upon creative identifiers that indicate operational features, the creative features associated with the creative identifiers, and the historical KPIs associated with the creative identifies. In some instances, creative identifiers of one source may be mapped to creative identifiers of another source, enabling the joining of data between these data sources. In this manner, the training data may include historical KPIs, operational features, and the creative features of each of the creatives in combined set(s) of training data.

Lastly, the Two-Stage Creative Analysis Machine Learning Engines are trained with the generated training data (block 208). For example, the training data set(s) are provided to the stage 1 operational model and the stage 2 creative feature residual model, enabling these models to predict subsequent KPI values for creatives. In some instances, the stage 1 operational model may receive training data related to the operational parameters, while the stage 2 creative feature residual model receives training data related to the creative features. In this manner, each of these models may predict based upon particular assigned features of the training data.

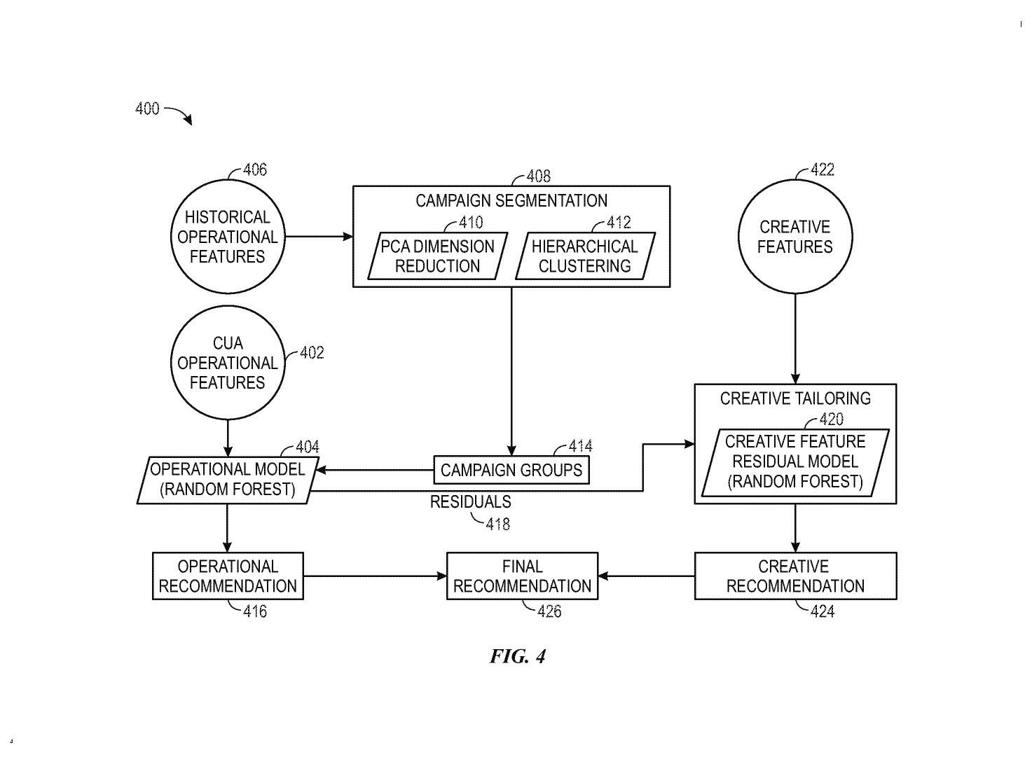

Having discussed the training of the models, the discussion continues with usage of the models for creative analysis. With this in mind, FIG. 3 is a flowchart, illustrating a process 300 for implementing creative analysis using the two-stage creative analysis engine, in accordance with certain aspects of the current application.

The process 300 begins with applying operational features of the Creative-Under-Analysis to the Operational Model to identify KPI prediction based upon operational variables of the Creative-Under-Analysis (block 302). As mentioned above, the Operational Model may use operational feature mapping to historical data and associated KPIs to determine KPI predictions based upon the operational features of the Creative-Under-Analysis. This model may also derive a list of operational features that most impact the KPI prediction (e.g., either positive or negative).

Next, residuals of the Operational Model are provided as target variables for the Creative Feature Residual Model. The creative features of the Creative-Under-Analysis are applied to the Creative Feature Residual Model to predict/estimate the residuals (block 304). For example, taking the attention index which may range from a normalized score of 1-100, the Operational Model may estimate an attention index value of 88 for a particular creative based upon operational features of the model. The stage 2 Creative Feature Residual Model may then predict incremental changes that each of a set of creative feature adjustments will make to the attention index value of 88. For example, the Creative Feature Residual Model may predict a residual improvement of 5 when a change to go from a dogless creative to one that adds a dog.

KPI predictions are generated and presented by summing the outputs of the Operational Model and the Creative Feature Residual Model (block 306). For example, returning to the example above, the overall attention index value with the dog added to the creative would be predicted as 93 (88 + 5).

Optionally, when the set of two-stage creative analysis engines 102 are tasked with generating creative modification recommendations, blocks 308 and 310 may be performed. Specifically, the set of two-stage creative analysis engines 102 may iteratively and individually adjust each creative feature to an opposite value and apply the opposite value to the Creative Feature Residual Model to identify an impact of the adjustment on the effectiveness (KPI) scoring (block 308). Key adjustments may be identified as a top set of adjustments or a set of adjustments exceeding a threshold that positively impact the KPI scoring.

The identified key creative feature improvements may be presented as recommended modifications (block 310). For example, these key creative feature improvements may be provided in a Creative Dashboard GUI, as will be discussed in more detail below.

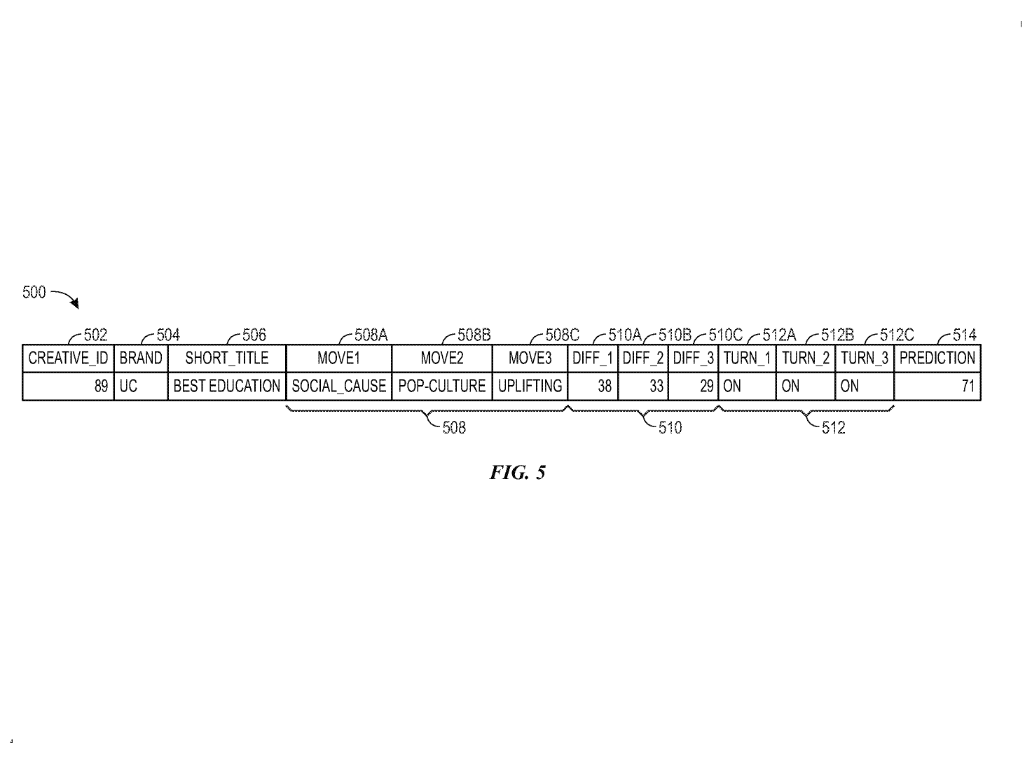

FIG. 4 is a data flow diagram 400, illustrating how recommendations are generated using the two-stage creative analysis engine, in accordance with certain aspects of the current application. Operational features 402 (e.g., of a Creative-Under-Analysis (CUA)) may be provided to the Operational Model 404, which in the depicted figure is a random forest model. As may be appreciated, a random forest model is learning model that operates by constructing a multitude of decisions trees at training time.

When the Creative-Under-Analysis is a new creative and has not previously aired and/or has been aired below a threshold amount, there may not be enough operational features of the Creative-Under-Analysis to derive accurate predictions by the Operational Model 404. Accordingly, a large set of Historical Operational Features 406 may be provided to a Campaign Segmentation Process 408, tasked with generating operational parameters historically representative for different levels of campaigns (e.g., a high-budget campaign, a medium-budget campaign, and a low-budget campaign). To do this, a Principal Component Analysis (PCA) Reduction Process 410 and a Hierarchical Clustering Process 412 is applied to the Historical Operational Features 406. The PCA Reduction Process 410 is tasked with reducing the number of operational features to those that provide the most impact for the various campaign levels. The Hierarchical Clustering Process 412 identifies operational parameters that cluster around a set of the top principal components (e.g., the top 8 principal components) and, thus, that may effectively represent the various campaign levels. The campaign groups 414 (and their associated operational features) are defined and provided to the Operational Model 404, enabling the Operational Model 404 to make predictions for each of the campaign groups 414. The number of top principal components may be determined based upon thresholding. For example, a threshold amount of coverage of operational parameters (e.g., 80%) by the principal components may dynamically change the number of principal components needed to reach this threshold.

The Operational Model 404 may provide an operational recommendation 416 and residuals 418. As used herein, residuals refer to a difference between the predicted KPI values and actual historical KPI values for a creative. The residuals 418 may be provided as a target to the Creative Feature Residual Model 420, which may also receive an indication of creative features 422 of the Creative-Under-Analysis. Using the creative features 422, the Creative Feature Residual Model 420 may identify a creative recommendation 424.

The operational recommendation 416 and the creative recommendation 424 may be provided as a final recommendation 426. For example, operational effectiveness and creative effectiveness predictions and/or adjustments to operational features and/or creative features to improve the Creative-Under-Analysis’ effectiveness may be generated and provided, for example, via a Creative Dashboard.

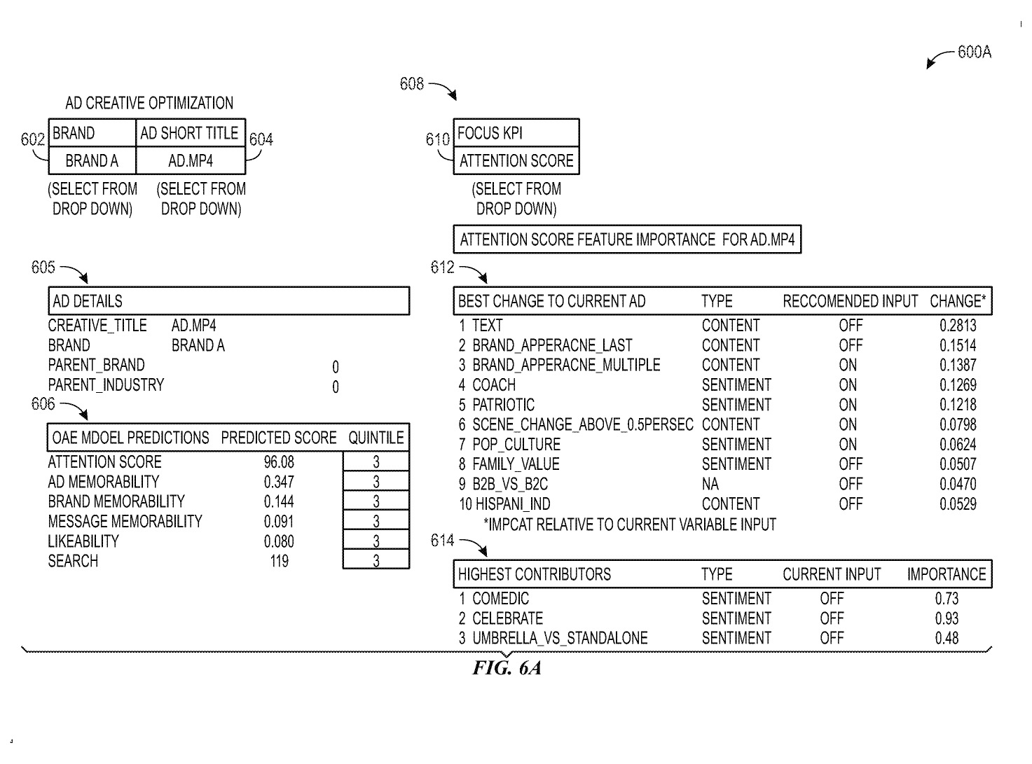

FIG. 5 is a schematic diagram, illustrating an example of a generated recommendation data structure 500 storing a resultant recommendation, in accordance with certain aspects of the current application. As illustrated, the recommendation data structure 500 may include a database record that stores particular information relating to creative and recommendations associated with the creative. For example, in the illustrated example, the Creative_id field 502 may provide a unique identifier for a particular Creative-Under-Analysis. The Brand field 504 may provide a brand associated with the creative. The Short_Title field 506 may include a brief title of the creative. Creative Modification fields 508 may provide a preset number of modifications. The Difference fields 510 provide corresponding predicted residual improvement associated with the Difference fields 510 and Turn fields 512 indicate a changed value associated with the Difference fields 510 to create the improved residuals.

As mentioned above, a preset number of modifications (e.g., 3, 4, 5, etc.) may be stored. The preset number may be adjusted based upon a number of recommendations that are desired to be presented. The modifications to be stored in the Creative Modification fields 508 may be selected based upon being identified as having the most positive residual impact to the predicted effectiveness score (which may be stored in Prediction field 514). In the depicted example, including a social cause, as indicated by Modification field 508A populated with “social_cause” and Turn field 512A populated with “ON”, is predicted to result in a residual improvement to the effectiveness score by 38, as indicated by Difference field 510A populated with “38”. The modification’s position in the first Move field 508a, Turn field 512A, and Difference field 510A may indicate that this the highest improving modification that was found in the available creative aspect modifications (e.g. identified in block 308 of FIG. 3). In other words, the predicted 38 point residual increase is the highest increase of all identified creative aspect modifications.

The Move field 508B provides a second highest predicted improvement modification. Specifically, as illustrated by this field and the Turn field 512B, adding a pop culture reference is predicted to provide a residual improvement of 33 points (as indicated by Difference field 510B). Further, a third highest improving modification includes adding in an uplifting message, as indicated by Move field 508C and Turn field 512C. This modification is predicted to provide a residual improvement of 29 points.

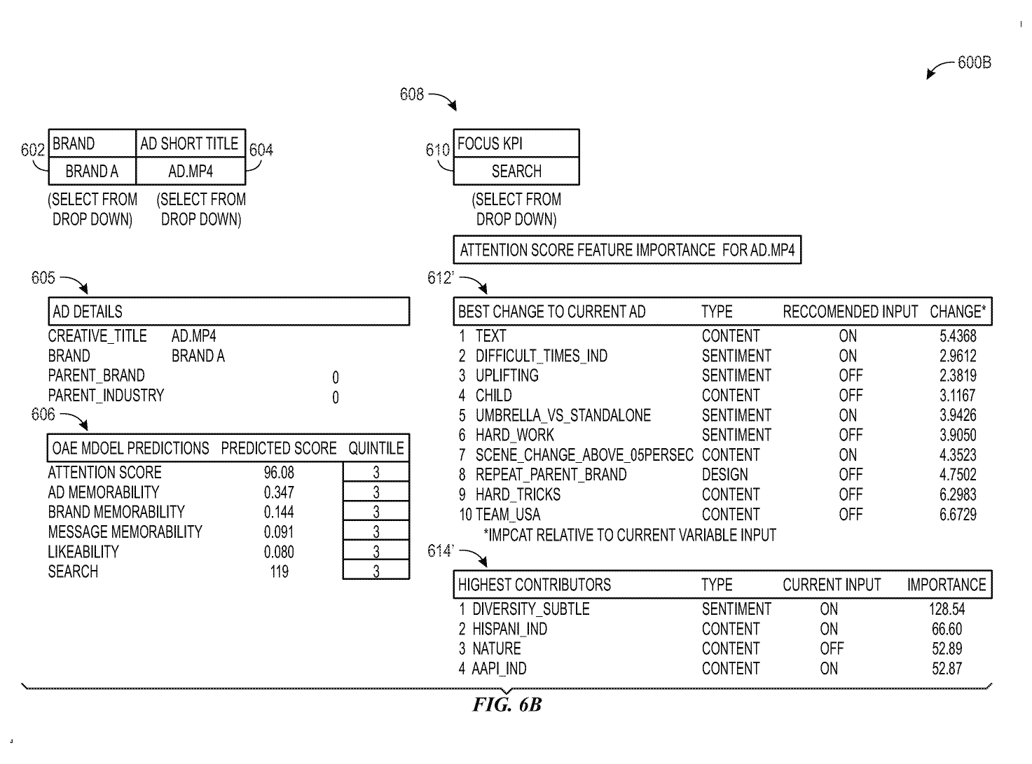

Having discussed generation of the predictions and recommendations, the discussion now turns to presentation of these results. FIG. 6A is a schematic diagram of a graphical user interface (GUI) 600 of creative dashboard that provides key performance indicator (KPI) scorings and particular information about a particular selected KPI (e.g., here Attention Score), in accordance with aspects of the present techniques.

As illustrated, the GUI 600 may include a brand selector 602 and creative selector 604. The brand selector 602 enables quick filtering of creatives of a particular brand. The creative selector 604 may provide a list of selectable creatives that may be selected as a Creative-Under-Analysis. Selection of a creative via the creative selector 604 may trigger the two-stage creative analysis and subsequent presentation of results of the two-stage creative analysis or may trigger presentation of results of a two-stage creative analysis previously performed (e.g., where results were preloaded into the Creative Dashboard).

The ad details section 605 provides various details regarding the Creative_Under_Analysis. For example, here, the title, brand, parent brand, and parent industry are presented.

The Overall Asset Effectiveness (OAE) Model Predictions section 606 provides results for each of the KPI predictions for the Creative_Under_Analysis. For example, here, an Attention Score prediction of 96.08, an Ad Memorability Score prediction of .347, a Brand Memorability Score prediction of .144, a Message Memorability score prediction of .091, a Likeability score prediction of .080, and a Search score prediction of 119 are provided.

An overall relativity metric regarding effectiveness compared to other creatives’ effectiveness may also be provided. For example, here, a relative Quintile range indicating which Quintile the creative’s predicted score is within is provided. This may provide a quick indication of how effective the Creative_Under_Analysis is compared to other analyzed creatives.

The Focus KPI section 608 provides particular information about a particular selected KPI. For example, a selection of a particular KPI may be made using KPI selector 610. Here, the Attention KPI is selected.

Based upon the selected KPI, best modification selections specific to the selected KPI are provided in the modification section 612. As illustrated , the suggested modifications may include content changes, sentiment changes, or other types of creative aspect changes. For example, with respect to improving the Attention KPI, removing text may result in a .2813 residual improvement. Removing a brand appearance in the last frame is predicted to result in a residual improvement of .1514. Adding multiple brand appearances in the creative is predicted to result in a residual improvement of .1387. Adding “coaching”, “patriotic”, “pop culture”, and “family value” sentiments are predicted to result in respective residual improvements of .1269, .1218, .0624, and .0507. Adjusting scene changes rates to above .5 per second is predicted to have a residual improvement of .0798. Changing from business-to-business (B2B) to business-to-consumer (B2C) ( represented by B2B_vs_B2C being off) is predicted to have a residual improvement of .0470. Further, adding Hispanic individuals is predicted to have a residual improvement of .0529.

Further, the Highest Contributors section 614 provides an indication of the highest contributors to the selected KPI’s predicted scoring (e.g., either positively and/or negatively). For example, here, having a non-comedic sentiment has a .73 importance score, while a non-celebratory sentiment has a .93 importance score and a non-umbrella_vs_standalone sentiment has a .48 importance score.

As may be appreciated, because the information in the Focus KPI section 608 is specific to the selected KPI, the information provided in the Focus KPI section 608 may change when a different KPI is selected via the KPI selector 610. FIG. 6B is a schematic diagram of the GUI 600 of FIG. 6A, with a modified KPI selection (e.g., Search) made via the KPI selector 610, in accordance with aspects of the present techniques.

As illustrated, the OAE Model Prediction Section 606 may stay the same as this section provides overall effectiveness metrics for the creative. However, the modification section 612’ and the Highest Contributors section 614’ section are changed to provide the best modifications and highest contributors, respectively, for the Search KPI (selected via KPI selector 610). For example, the recommended modifications include content recommendations, such as featuring a celebrity (with a predicted residual improvement of 5.4368), removing children (with a predicted residual improvement of 3.1167), scene changes above .5 per second (with a predicted residual improvement of 4.3523), not featuring hard tricks (with a predicted residual improvement of 6.2983) and not featuring Team USA (with a predicted residual improvement of 6.6729). Sentiment recommendations include: including a difficult times sentiment (with a predicted residual improvement of 2.9612), removing an uplifting sentiment (with a predicted residual improvement of 2.3819), including an umbrella vs. standalone sentiment (with a predicted residual improvement of 3.9426), and removing a hard work sentiment (with a predicted residual improvement of 3.9050). Design recommendations include turning off repetitive parent branding within the creative (with a predicted residual improvement of 4.7502).

The highest contributors resulting in the search score are a subtle diversity sentiment (with an importance score of 128.54), the creative content including a Hispanic individual (with an importance score of 66.60), the content not including nature (with an importance score of 52.89), and the content including Asian American and Pacific Islander individuals (with an importance score of 52.87).

As may be appreciated, the predictions, recommendations, and relevant associated data (e.g., contributing factors) may efficiently and effectively provide a quality analysis of the effectiveness of a creative for a wide range of audience members. The vast amount of training data may help ensure accurate predictions that provide better representation of a viewing audience than traditional control groups. Further, through insights gleaned by the models, recommended modifications to improve the predicted effectiveness may be provided.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A system comprising:
a two-stage creative analysis machine learning engine, comprising:
a first stage machine learning model, configured to predict a key performance indicator (KPI) value for a creative based upon operational features of the creative; and
a second stage machine learning model, configured to predict residuals of the first stage machine learning model based upon creative features of the creative.

2. The system of claim 1, comprising:
a creative dashboard, configured to present the predicted KPI value and the predicted residuals.

3. The system of claim 1, wherein the two-stage creative analysis machine learning engine is configured to:
identify one or more campaign groups comprising a subset of historical operational features representative of one or more campaign classifications; and
when the creative has below a threshold of operational features, use the subset of historical operation features of the one or more campaign groups as the operational features of the creative to predict the KPI value via the first stage machine learning model.

4. The system of claim 3, wherein the two-stage creative analysis machine learning engine is configured to identify the subset of historical operational features of the one or more campaign groups by:
performing Principal Component Analysis (PCA) reduction on the historical operational features to identify a subset of principal operational features that impact the KPI value;
performing hierarchical clustering around the subset of principal operational features; and
selecting the subset of historical operational features based upon the hierarchical clustering.

5. The system of claim 3, wherein the one or more campaign groups comprise three campaign groups: a high budget campaign group, a medium budget campaign group, and a low budget campaign group.

6. The system of claim 1, wherein the first stage machine learning model, the second stage machine learning model, or both comprise a random forest model.

7. The system of claim 1, wherein the two-stage creative analysis machine learning engine is configured to identify key creative features of the creative predicted to impact the KPI value, by:
incrementally, for each creative feature of the creative, adjusting the creative feature and applying the adjusted creative feature to the second stage machine learning model, to identify a predicted impact to the predicted residuals; and
selecting a predetermined number of the most impactful adjusted creative features as the key creative features.

8. The system of claim 1, comprising:
training data used to train the first stage machine learning model and the second stage machine learning model, generated by joining historical operational features, historical KPI values, and creative features of the creative.

9. The system of claim 1, configured to:
identify the creative features of the creative by analyzing the creative using generative artificial intelligence, computer vision, or both; and
tag the creative with the identified creative features.

10. The system of claim 1, comprising a plurality of two-stage creative analysis machine learning engines, one for each of a plurality of KPIs.

11. The system of claim 10, wherein the KPIs comprise: an attention index, a search, creative memorability, brand memorability, likability, message memorability, or any combination thereof.

12. A computer-implemented method, comprising:
predicting, via a first stage machine learning model, a key performance indicator (KPI) value for a creative based upon operational features of the creative; and
predicting, via a second stage machine learning model, residuals of the first stage machine learning model based upon creative features of the creative.

13. The computer-implemented method of claim 12, comprising:
presenting, via a creative dashboard, the predicted KPI value and the predicted residuals.

14. The computer-implemented method of claim 12, comprising:
identifying one or more campaign groups comprising a subset of historical operational features representative of one or more campaign classifications;
identifying that the creative has below a threshold of operational features; and
in response to identifying that the creative has below the threshold of operational features, using the subset of historical operation features of the one or more campaign groups as the operational features of the creative to predict the KPI value via the first stage machine learning model.

15. The computer-implemented method of claim 14, comprising identifying the subset of historical operational features of the one or more campaign groups by:
performing Principal Component Analysis (PCA) reduction on the historical operational features to identify a subset of principal operational features that impact the KPI value;
performing hierarchical clustering around the subset of principal operational features; and
selecting the subset of historical operational features based upon the hierarchical clustering.

16. The computer-implemented method of claim 12, comprising identifying key creative features of the creative predicted to impact the KPI value, by:
incrementally, for each creative feature of the creative, adjusting the creative feature and applying the adjusted creative feature to the second stage machine learning model, to identify a predicted impact to the predicted residuals; and
selecting a predetermined number of the most impactful adjusted creative features as the key creative features.

17. The computer-implemented method of claim 12, comprising
generating training data used to train the first stage machine learning model and the second stage machine learning model, by joining historical operational features, historical KPI values, and creative features of the creative; and
training the first stage machine learning model and the second stage machine learning model using the training data.

18. A tangible, non-transitory, computer-readable medium, comprising computer-readable instructions that, when executed by one or more processors of one or more computers, cause the one or more computers to:
predict, via a first stage machine learning model, a key performance indicator (KPI) value for a creative based upon operational features of the creative;
predict, via a second stage machine learning model, residuals of the first stage machine learning model based upon creative features of the creative; and
present, via a creative dashboard, the predicted KPI value and the predicted residuals.

19. The tangible, non-transitory, computer-readable medium of claim 18, comprising computer-readable instructions that, when executed by the one or more processors, cause the one or more computers to:
identify one or more campaign groups comprising a subset of historical operational features representative of one or more campaign classifications, by:
performing Principal Component Analysis (PCA) reduction on the historical operational features to identify a subset of principal operational features that impact the KPI value;
performing hierarchical clustering around the subset of principal operational features; and
selecting the subset of historical operational features based upon the hierarchical clustering;
identify that the creative has below a threshold of operational features; and
in response to identifying that the creative has below the threshold of operational features, use the subset of historical operation features of the one or more campaign groups as the operational features of the creative to predict the KPI value via the first stage machine learning model.

20. The tangible, non-transitory, computer-readable medium of claim 18, comprising computer-readable instructions that, when executed by the one or more processors, cause the one or more computers to identify key creative features of the creative predicted to impact the KPI value, by:
incrementally, for each creative feature of the creative, adjusting the creative feature and applying the adjusted creative feature to the second stage machine learning model, to identify a predicted impact to the predicted residuals; and
selecting a predetermined number of the most impactful adjusted creative features as the key creative features.
